(19) United States
(12) Patent Application Publication
(10) Pub. No.: US 2022/0036167 A1
(43) Pub. Date: Feb. 3, 2022

(54) SORTING METHOD, OPERATION METHOD AND OPERATION APPARATUS FOR CONVOLUTIONAL NEURAL NETWORK

(71) Applicant: Xiamen SigmaStar Technology Ltd., Fujian (CN)

(72) Inventors: Chao LI, Shanghai (CN); Wei ZHU, Shanghai (CN); Bo LIN, Shanghai (CN)

(21) Appl. No.: 17/335,569

(22) Filed: Jun. 1, 2021

(30) Foreign Application Priority Data
Jul. 31, 2020 (CN) 202010761715.4

(51) Int. Cl. G06N 3/063; G06F 7/24; G06F 7/544; G06F 7/523; G06F 7/50

(52) U.S. Cl. CPC G06N 3/063; G06F 7/24; G06F 7/50; G06F 7/523; G06F 7/5443

(57) ABSTRACT

An operation method in a convolutional neural network applied to an electronic apparatus having a memory storing convolutional kernel data having undergone a sorting process. The operation method includes: performing the sorting process on a first feature vector of feature map data under process according to a marking sequence corresponding to a first weighting vector of the convolutional kernel data having undergone the sorting process; removing a part of feature values in the first feature vector having undergone the sorting process to generate a second feature vector; and performing a multiply accumulation operation on the basis of the first weighting vector and the second feature vector. The convolutional kernel data having undergone the sorting process is obtained by means of performing sorting and zero-weighting removal processes, and the marking sequence is generated according to the sorting and zero-weighting removal processes corresponding to the first weighting vector.

This application claims the benefit of China application Serial No. CN202010761715.4, filed on Jul. 31, 2020, the subject matter of which is incorporated herein by reference.

### BACKGROUND OF THE INVENTION

### Field of the Invention

The invention relates to the technical field of data processing, and more particularly, to a sorting method and an operation method and apparatus for a convolutional neural network.

### Description of the Related Art

Deep learning is one critical application technology for developing artificial intelligence, and is extensively applied in fields including computer vision and voice recognition. Convolutional neural networking (CNN) is a deep learning efficient recognition technology that has drawn much attention in the recent years. It performs convolution operations and vector operations of multiple layers with multiple feature filters by directly inputting original image or data, further generating highly accurate results in aspects of imaging and voice recognition.

However, the development and extensive application of convolutional neural networking also bring an increasing number of challenges. For example, the scale of parameters of a CNN model becomes larger, such that the amount of calculation needed by the CNN model becomes enormous, e.g., the number of layers of a depth residual neural network (ResNet) is as many as 152 layers, each of which having a large number of weighting parameters. A convolutional neural network, acting as an algorithm with a great calculation amount and a great access amount, has elevated calculation amount and access amount as the number of weighting values increases. Thus, different methods for compressing the scale of CNN models have been proposed; however, a substantial amount of sparse data is frequently produced in a compressed CNN model. In a convolutional neural network, sparse data refers to weighting values valued as zero, and these weighting values valued as zero are scattered and irregularly distributed in convolutional kernel data, in a way that a convolutional neural network generating the sparse data becomes a sparse convolutional neural network. If calculation is directly performed on the sparse data structure, waste on hardware performance and calculation resources can be resulted, such that it becomes difficult to improve the operation speed of the CNN model.

### SUMMARY OF THE INVENTION

In view of the issues of the prior art, it is an object of the present invention to provide a sorting method and an operation method and apparatus for a convolutional neural network so as to improve the prior art.

The present invention provides an operation method for a convolutional neural network applied to an electronic apparatus, wherein a memory in the electronic apparatus stores convolutional kernel data having undergone a sorting process. The operation method includes: performing the sorting process on a first feature vector of feature map data under process according to a marking sequence corresponding to a first weighting vector of the convolutional kernel data having undergone the sorting process; removing a part of feature values in the first feature vector having undergone the sorting process to generate a second feature vector; and performing a multiply accumulation operation on the basis of the first weighting vector and the second feature vector. The convolutional kernel data having undergone the sorting process is obtained by means of sorting and zero-weighting removal processes, and the marking sequence is generated according to the sorting process and zero-weighting removal processes corresponding to the first weighting vector.

The present invention further provides a data sorting method for a convolutional neural network. The data sorting method includes: acquiring first convolutional kernel data; splitting the first convolutional kernel data into a plurality of second weighting vectors in a channel direction; generating a plurality of marking sequences corresponding to the second weighting vectors according to positions of zero weightings in the second weighting vectors; performing a sorting process on weightings of the second weighting vectors according to the marking sequences so that the zero weightings are arranged on one ends of the second weighting vectors; and removing at least one zero weighting arranged on the one ends of second weighting vectors to obtain a plurality of corresponding first weighting vectors, wherein the first weighting vectors form convolutional kernel data having undergone the sorting process.

The present invention further provides an operation apparatus for a convolutional neural network applied to an electronic apparatus, wherein a memory in the electronic apparatus stores convolutional kernel data having undergone a sorting process. The operation apparatus for a convolutional neural network includes a sorting circuit and a multiply accumulation operation circuit. The sorting circuit performs the sorting process on a first feature vector of feature map data under process according to a marking sequence corresponding to a first weighting vector of the convolutional kernel data having undergone the sorting process, and removes a part of feature values in the first feature vector having undergone the sorting process to generate a second feature vector. The multiply accumulation operation circuit performs a multiply accumulation operation on the basis of the first weighting vector and the second feature vector. The convolutional kernel data having undergone the sorting process is obtained by means of sorting and zero-weighting removal processes, and the marking sequence is generated according to the sorting and zero-weighting removal processes corresponding to the first weighting vector.

Features, implementations and effects of the present invention are described in detail with the accompanying drawings below.

### BRIEF DESCRIPTION OF THE DRAWINGS

FIG. 1A is a flowchart of a sparse data sorting method for a convolutional kernel network according to an embodiment of the present invention;

FIG. 1B is a schematic diagram of a convolution operation according to an embodiment of the present invention;

FIG. 1C is another schematic diagram of a convolution operation in a sparse data sorting method for a convolutional neural network according to an embodiment of the present invention;

FIG. 1D is a schematic diagram of bitonal sort in a sparse data sorting method for a convolutional neural network according to an embodiment of the present invention;

FIG. 2A is a flowchart of an operation method for a sparse convolutional neural network according to an embodiment of the present invention;

FIG. 2B is a schematic diagram of a scenario of an operation method for a sparse convolutional neural network according to an embodiment of the present invention; and

FIG. 3 is a schematic diagram of a structure of an operation apparatus for a sparse convolutional neural network according to an embodiment of the present invention.

### DETAILED DESCRIPTION OF THE INVENTION

The technical solutions of the embodiments of the present invention are clearly and comprehensively described with the accompanying drawings of the embodiments of the present invention below. It is apparent that the described embodiments are merely some embodiments but not all embodiments of the present invention. On the basis of the embodiments of the present invention, all other embodiments arrived by a person of ordinary skill in the art without involving inventive skills are to be encompassed within the scope of the protection of the present invention.

A sparse data sorting method for a convolutional neural network is provided according to an embodiment of the present invention. An execution entity of the sparse data sorting method for a convolutional neural network may be a sparse data sorting apparatus for a convolutional neural network provided by an embodiment of the present invention, or may be electronic equipment integrated with the sparse data sorting apparatus for a convolutional neural network. The sparse data sorting apparatus for a convolutional neural network may be implemented in form of hardware or software. The electronic equipment may be a smart terminal integrated with a convolutional neural network operation chip, for example, a smart phone, smart in-vehicle equipment or smart monitoring equipment. Alternatively, the electronic equipment may be a server, a user may upload a trained convolutional neural network to the server, and the server may perform a sparse data sorting process on a convolutional neural network on the basis of the solutions of the embodiments of the present invention.

The embodiments of the present invention are applicable to a convolutional neural network (to be referred to as a CNN below) of any structure, and the CNN of the embodiment of the present invention may further include a pooling layer and a fully connection layer. That is to say, sparse data sorting of the present invention is not limited to being applied to a specific type of convolutional neural network, and any neural network including a convolutional layer may be considered the “convolutional neural network” in the present invention.

In the sparse data sorting method for a convolutional neural network provided according to an embodiment of the present invention, sparse data is removed by means of compressing convolutional kernel data in the CNN in a channel direction. There are various reasons why sparse data is generated. For example, the scale of the CNN is compressed according to a certain algorithm, and a sparse CNN is often obtained after the compression; that is, numerous weighting values in the convolutional kernel data of the CNN are equal to zero, and sometimes the level of sparsity in some CNNs may even be as high as 50% or more. The level of sparsity of a CNN gets higher as the number of zero weightings increases. During a convolution operation, the result of multiplication of a zero weighting and a feature value of an inputted feature map is zero, regardless of the value of the feature value. Thus, in addition to causing waste on hardware performance and calculation resources, no contribution at all is provided for the convolution result. For example, the calculation ability provided by electronic equipment is limited; assuming the calculation ability of one multiply accumulation cell (MAC) is 256, the MAC then has 256 multipliers. In case of 100 out of 256 weighting values inputted one time into the MAC are zero, resources of 100 multipliers are wasted, and also because the result of the multiplication operation is zero, no effect is provided in the subsequent multiply accumulation. Therefore, when a large number of zero weightings exist in an entire convolutional neural network, the effective utilization rate of the MAC is extremely low, further leading to poor operation efficiency of the entire convolutional neural network.

The sparse data sorting method for a convolutional neural network of the present invention can remove sparse data from the convolutional neural network, so as to reduce the level of sparsity of the convolutional neural network and enhance the utilization rate of a MAC, thereby preventing waste on calculation resources as well as enhancing operation efficiency of the convolutional neural network.

It should be noted that, the convolutional neural network of the embodiment of the present invention is applicable to numerous scenarios, for example, fields of image recognition such as face recognition and license plate recognition, fields of feature extraction such as image feature extraction and voice feature extraction, fields of voice recognition and fields of natural language processing. Images or images obtained from converting data in other forms are inputted to a pre-trained convolutional neural network, and operations can then be performed using the convolutional neural network, so as to achieve an object of classification, recognition or feature extraction.

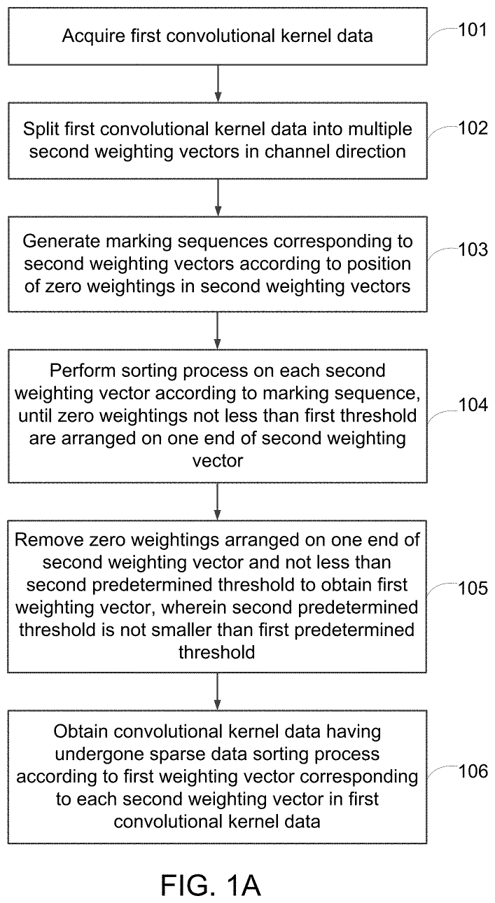

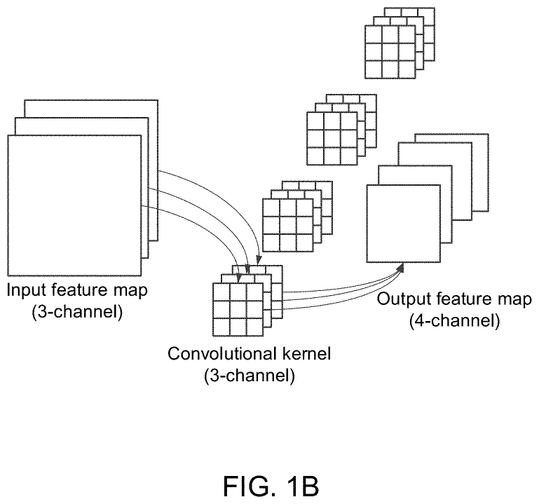

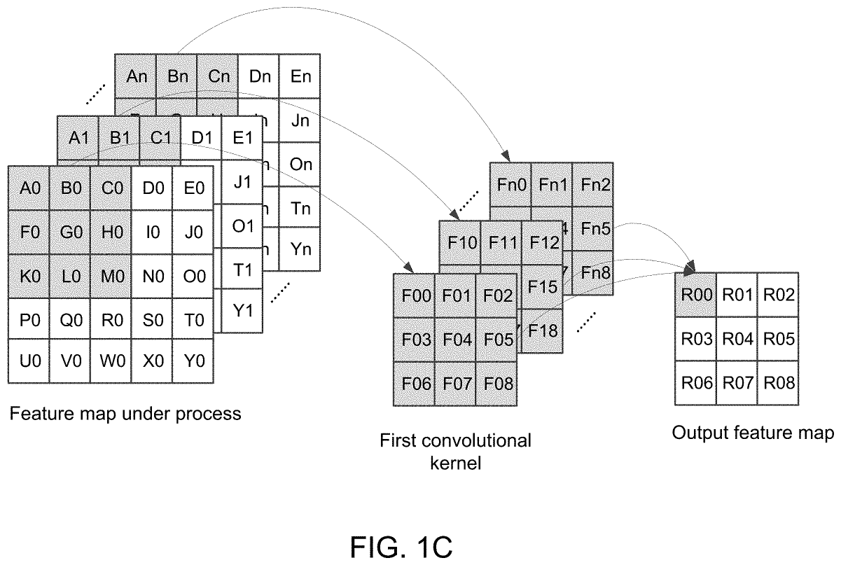

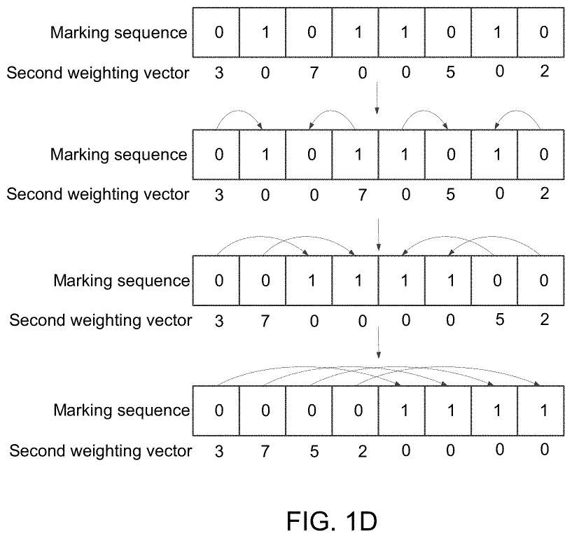

FIG. 1A shows a flowchart of a sparse data sorting method for a convolutional neural network according to an embodiment of the present invention. Referring to FIG. 1A, the process is specifically as below.

In step 101, first convolutional kernel data is obtained.

A target convolutional layer is determined from a convolutional neural network that is to undergo a sparse data sorting process, as an object of the sparse data sorting process. Alternatively, first convolutional kernel data sent from other equipment is directly received for the sparse data sorting process. To distinguish convolutional kernel data before from convolutional kernel data after the sparse data sorting process, the convolutional kernel data before the sparse data sorting process is referred to as the first convolutional kernel data. It should be noted that, the term “first” herein is for data distinguishing, and is not to be interpreted as a limitation to the solution.

The convolutional layer performs a convolution operation on an input feature map to obtain an output feature map. That is to say, data inputted to the operation apparatus includes feature map data and convolutional kernel data. The feature map data may be original image or voice data (e.g., voice data converted to the form of a spectrogram), or feature map data outputted from a previous convolutional layer (or pooling layer). For the current target convolutional layer, all the data above may be considered a feature map that is to be processed (under process).

The feature map under process may have a plurality of channels, and the feature map on each channel may be understood as a two-dimensional image. When the number of channels of the feature map under process is more than 1, the feature map under process may be understood as a three-dimensional feature map formed by overlaying the two-dimensional images of the plurality of channels, wherein the depth of the three-dimensional feature map is the number of channels. The number of channels of each set of convolutional kernel data of the target convolutional layer is equal to the number of channels of the feature map inputted to the layer, and the number of sets of the convolutional kernel data is equal to the number of the channels of the feature map outputted from the target convolutional layer. That is to say, one two-dimensional image is obtained after a convolution operation is performed on the input feature map and one set of convolutional kernel data.

For example, referring to FIG. 1B, FIG. 1B shows a schematic diagram of convolution operation according to an embodiment of the present invention. Herein, a 3-channel 5×5-pixel input feature map is taken as an example. The convolutional kernel data (also referred to as feature filter data or feature screening program data) is one set of parameter values for identifying certain feature of an image, and is generally in a scale of dimensions including 1×1, 3×3, 3×5, 5×5, 7×7 and 11×11 on a two-dimensional plane, and the number of convolutional kernel data coincides with the number of channels of an input feature map. Herein, common 3×3 convolutional kernel data is taken as an example, the number of sets of the convolutional kernel data is 4, and so the number of channels of an output feature map is also 4. The process of the convolution operation is: four sets of 3×3×3 convolutional kernel data is moved sequentially on a 5×5×3 feature map to thereby generate a sliding window on the feature map. The distance of each movement is referred to as a “stride”, the stride is less than the shortest width of the convolutional kernel data, and the convolution operation in a unit of the dimensions of the convolutional kernel data is performed once on the corresponding data in the sliding window each time the convolutional kernel data moves. Taking the map above for instance, the stride is 1, a 3×3×3 convolution operation is performed once each time the convolutional kernel data moves on the feature map, and a final result is referred to as an output feature value.

In step 102, the first convolutional kernel data is split into a plurality of second weighting vectors in the channel direction.

FIG. 10 shows another schematic diagram of a convolution operation in a sparse data sorting method for a convolutional neural network according to an embodiment of the present invention. Assuming that the dimensions of the feature map under process are 5×5×(n+1) and the dimensions of the first convolutional kernel data are 3×3×(n+1), after the convolution operation is performed for the first convolutional kernel data on the feature map under process, the first feature value of the output feature map is R00=((A0×F00)+(B0×F01)+(C0×F02)+(F0×F03)+(G0×F04)+(H0×F05)+(K0×F06)+(L0×F07)+(M0×F08))+((A1×F10)+(B1×F11)+(C1×F12)+(F1×F13)+(G1×F14)+(H1×F15)+(K1×F16)+(L1×F17)+(M1×F18))+ . . . +((An×Fn0)+(Bn×Fn1)+(Cn×Fn2)+(Fn×Fn3)+(Gn×Fn4)+(Hn×Fn5)+(Kn×Fn6)+(Ln×Fn7)+(Mn×Fn8)). The remaining feature values of the output feature map are obtained by the similar calculation. Based on such characteristics, the convolution operation of the first convolutional kernel data and the feature map under process may be converted to an inner product operation between weighting vectors of the first convolutional kernel data in the channel direction feature vectors of the feature map under process in the channel direction. The operation method is as below.

R00=((A0×F00)+(A1×F10)+ . . . +(An×Fn0))+((B0×F01)+(B1×F11)+ . . . +(Bn×Fn1))+((C0×F02)+(C1×F12)+ . . . +(Cn×Fn2))+((F0×F03)+(F1×F13)+(Fn×Fn3))+((G0×F04)+(G1×F14)+ . . . +(Gn×Fn4))+((H0×F05)+(H1×F15)+ . . . +(Hn×Fn5))+((K0×F06)+(K1×F16)+ . . . +(Kn×Fn6))+((L0×F07)+(L1×F17)+ . . . +(Ln×Fn7))+((M0×F08)+(M1×F18)+ . . . +(Mn×Fn8)).

On the basis of the above, the first convolutional kernel data may be split into a plurality of second weighting vectors in the channel direction, and the sparse data sorting process may be performed individually.

For example, the 3×3×(n+1) first convolutional kernel data may be split into 9k second weighting vectors in the channel direction, and the length of the second weighting vectors is equal to (n+1)/k, where k may be valued as 1, 2, 3 . . . . The value of k is determined according to the number of channels of the first convolutional kernel data; for example, when n=64, the first convolutional kernel data may then be split into 18 second weighting vectors having a length of 32 in the channel direction, that is, k=2.

In step 103, marking sequences corresponding to the second weighting vectors are generated according to positions of zero weightings in the second weighting vectors.

After the second weighting vectors are obtained, for each second weighting vector, a corresponding marking sequence is generated according to positions of zero weightings therein. For example, in one embodiment, the zero weightings in the second weighting vector are replaced by a first value, and non-zero weightings are replaced by a second value to obtain a marking sequence, wherein the first value is greater than the second value. For example, the first value is 1 and the second value is 0. Assuming that the second weighting vector is (3, 0, 7, 0, 0, 5, 0, 2), the corresponding marking sequence (0, 1, 0, 1, 1, 0, 1, 0) is generated; that is, zero weightings are replaced by 1 and non-zero weightings are replaced by 0, and it is seen that the second weighting vector having a length of 8 has 4 zero weightings.

In step 104, a sorting process is performed on the weightings in each second weighting vector according to the marking sequence.

After the marking sequence is generated, a sorting process is performed on the weightings in the second weighting vector according to the marking sequence, and the purpose of sorting is to arrange the zero weightings on one end of the vector and to remove the zero weightings.

In practice, a sorting process may be performed on the marking sequence by a parallel sorting method such as bubble sort, merge sort or bitonic sort using multiple comparators. Due to the large number of convolutional data parameters, a sorting process may be performed on the marking sequence by a parallel sorting method using multiple comparators, and most zero weightings in the convolutional kernel data may be quickly gathered to one end and be removed, hence enhancing the efficiency of the sparse data sorting process.

For example, in the first method, a sorting process is performed on the marking sequence according to a bitonic sort algorithm, until the values in the marking sequence are arranged in an increasing order. During the sorting process, each time a change occurs in the values in the marking sequence, the position of the weighting on the same position in the second weighting vector is correspondingly adjusted.

The bitonic sort algorithm can convert an unordered numeral sequence to a bitonic sequence by means of sorting, and then convert the bitonic sequence to an ordered sequence. For example, the marking sequence (0, 1, 0, 1, 1, 0, 1, 0) is an unordered sequence, a bitonic sequence (0, 0, 1, 1, 1, 1, 1, 0) can be obtained by sorting according to a bitonic sort algorithm, and an ordered sequence (0, 0, 0, 0, 1, 1, 1, 1) can be obtained by further sorting the bitonic sequence.

In the sorting process, when the positions of the values in the marking sequence change once, the positions of the weightings at the corresponding positions in the second weighting vector also need be adjusted once. FIG. 1D shows a schematic diagram of bitonic sort of a sparse data sorting method for a convolutional kernel neural network in an embodiment of the present invention. Referring to FIG. 1 D, after sorting, the marking sequence is (0, 0, 0, 0, 1, 1, 1, 1), and the corresponding second weighting vector is (3, 7, 5, 2, 0, 0, 0, 0). It is seen that, after sorting, the zero weightings in the second weighting vector are arranged on one end of the vector, and the second weighting vector may be truncated at this point to remove a part or all the zero weightings to generate a first weighting vector. For example, 4 zero weightings are removed to obtain the first weighting vector (3, 7, 5, 2)—the length of the original second weighting vector is reduced by one half, achieving the effect of removing sparse data.

For example, the first convolutional kernel data has dimensions of 3×3×64 and is split into 9 second weighting vectors each having a length of 64, the number of zero weightings in each second weighting vector is calculated to obtain calculation results including 32, 32, 36, 40, 48, 50, 38, 51 and 47, and the minimum value 32 may then be used as the value of a first predetermined threshold. Provided that the second weighting vector is sorted into an ordered sequence according to the bitonic sort algorithm, there are necessarily zero weightings not less than the first predetermined threshold arranged on one end of the second weighting vector.

Bitonic sort is described herein. Regarding bubble sort and merge sort having similar principles of arranging zero weightings in a marking sequence to one end of the vector, details of these algorithms that can sort marking sequences in parallel using multiple comparators are not further described.

For another example, in the second method, the sorting process is performed on the marking sequence according to the bitonic sort algorithm, until the first values in the marking sequence that are not less than the first predetermined threshold are arranged on one end of the marking sequence. Moreover, during the sorting process, each time a change occurs in the values in the marking sequence, the position of the weighting on the same position in the second weighting vector is correspondingly adjusted. In this embodiment, the sorting process is simplified, and sorting is terminated once the first values not less than the first predetermined threshold are arranged on one end of the marking sequence. The first predetermined value may be an experience value, or may be a value intelligently determined by the electronic equipment according to the distribution and the number of zero weightings in the first convolutional kernel data.

For example, in one embodiment, the first convolutional kernel data has dimensions of 3×3×64 and is split into 9 second weighting vectors having a length of 64, the number of zero weightings in each of the second weighting vectors is calculated, the calculation results are 32, 32, 36, 40, 48, 50, 38, 51 and 47, and the minimum value 32 may be used as the value of the first predetermined threshold. As the first predetermined threshold is equal to 32, when bitonic sort is performed, the sorting may be terminated once there are 32 zero weightings arranged on one end of the vector.

In another embodiment, the number of sorting of the sorting process may be configured. The process of bitonic sort is fixed, in which 2^{t-1} comparators are needed for an unordered sequence consisting of 2^{t} numerals and partial sorting of log t is performed. Thus, the sorting process is performed according to the strides 2⁰, 2¹, 2², . . . 2^{t-1}, and an ordered sequence can be obtained after Σ₁^{t}i times of sorting. On this basis, according to the value of the first predetermined threshold, the number of times of sorting needing to be performed may be determined in advance. During the sorting process, once the number of times of sorting reaches the predetermined number of times of sorting, sorting may be terminated. For example, for a marking sequence consisting of 2^{t} numerals, 2^{t-1} comparators are used to perform sorting for Σ₁^{t}(i−1)+1 number of times, so as to arranged at least 2^{t-1} zero weightings on one end of the second weighting vector, where i∈(1, t). That is to say, in this embodiment, the first predetermined threshold may be equal to 2^{t-1}. When the level of sparsity of the convolutional kernel data is greater than 50%, the number of times of sorting may be determined according to the formula above. In practice, the first predetermined threshold and the number of times of sorting may be configured according to the level of sparsity of the convolutional kernel data.

In step 105, at least one zero weighting arranged on one end of the second weighting vector is removed to obtain a first weighting vector.

After completing the sorting, zero weightings not less than a second predetermined threshold and arranged on one end of the second vector may be removed, wherein the second predetermined threshold may be greater than or equal to the first predetermined threshold.

For example, in a first method, the second predetermined threshold is equal to the first predetermined threshold. Assuming that the first convolutional kernel data has dimensions of 3×3×64 and is split into 9 second weighting vectors having a length of 64, the number of zero weightings in each of the second weighting vectors is calculated, the calculation results are 32, 32, 36, 40, 48, 50, 38, 51 and 47, and the minimum value 32 may be used as the value of the first predetermined threshold. As the second predetermined threshold is also equal to 32, the 32 zero weightings are then removed. Thus, after the zero-weighting removal process performed on the 9 second weighting vectors having a length of 64, 9 first weighting vectors having a length of 32 are finally obtained. To ensure that the first weighting vectors of the first convolutional kernel data have equal lengths, the numbers of zero weightings removed therefrom are the same. Consequently, it is possible that some zero weightings are left unremoved from some first weighting vectors, and this is to ensure that valid non-zero weightings are preserved.

For another example, in a second method, the number of zero weightings in each of the second weighting vectors is calculated, the minimum therein is first eliminated, and the minimum value in the remaining values apart from the eliminated minimum value is used as the second predetermined threshold.

For yet another example, in a third method, valid non-zero weightings are sacrificed to a certain level. For example, the number of zero weightings in each of the second weighting vectors is calculated, and an average or a median of the values is used as the second predetermined threshold. As such, some non-zero weightings may be removed when zero weightings are removed; however, compared to the first method, a greater ratio of zero weightings may be removed to remove sparse data to a larger extent, hence more extensively preventing waste on hardware performance and calculation resources.

In step 106, convolutional kernel data having undergone the sparse data sorting process is obtained according to the first weighting vector corresponding to each of the second weighting vectors of the first convolutional kernel data.

The sorting process and zero-weighting removal process are performed on each of the second weighting vectors according to the method above to obtain corresponding first weighting vectors. The first weighting vectors having the same length form the convolutional kernel data having undergone the sparse data sorting process.

After the electronic equipment obtains the convolutional kernel data having undergone the sorting process with respect to the target convolutional layer, while storing the convolutional kernel data having undergone the sorting process, the marking sequence corresponding to each of the first weighting vectors is also stored. To perform an operation on the input feature map using the target convolutional layer, the same sorting process and removal process need to be performed on the feature values in the input feature map by using the marking sequences, so as to ensure that each weighting value multiplies the corresponding feature value. For example, referring to FIG. 10, for the first output feature value R00, the feature value matching the weighting F00 is A0. Since a change has occurred in the position of F00 in the depth direction during the sparse data sorting process, the position of A0 before the convolution operation also needs to be adjusted to the same position, and so (A0, A1, A2, . . . , An) need to be sorted according to the method used for (F00, F01, F02, . . . , F0n).

In actual implementation, the present invention is not limited to the execution sequence of the steps described above. Without incurring contradictions, some steps may be performed according to other sequences or be performed simultaneously.

In addition, it should be understood that, if a target convolutional layer has multiple sets of first convolutional kernel data, the sparse data sorting process may be performed on each set of the first convolutional kernel data. After the convolutional kernel data having undergone the sparse data sorting process is obtained, the method further includes: when the target convolutional layer has multiple sets of first convolutional kernel data, returning to the step of acquiring the first convolutional kernel data on the basis of new first convolutional kernel data, until the sparse data sorting process on the target convolutional layer is complete.

If one convolutional neural network includes multiple convolutional layers, the sparse data sorting process may be performed on each of the convolutional layers. After the sparse data sorting process on the target convolutional layer is complete, the method further includes: when the predetermined convolutional neural network includes multiple convolutional layers, acquiring a next convolutional layer of the target convolutional layer as a new target convolutional layer; and returning to the step of acquiring the first convolutional kernel data on the basis of the new target convolutional layer, until the sparse data sorting process on all the convolutional layers in the predetermined convolutional neural network is complete.

The convolutional neural network obtained by the sparse data sorting solution for the convolutional neural network above may be applied to a convolution operation according to an operation method for a sparse convolutional neural network below.

An operation method for a sparse convolutional neural network is further provided according to an embodiment of the present invention. An execution entity of the sparse convolutional neural network may be an operation apparatus for a sparse convolutional neural network provided by an embodiment of the present invention, or electronic equipment, wherein operation apparatus for a sparse convolutional neural network may be implemented in form of hardware or software, and the electronic equipment may be a smart terminal integrated with a convolutional neural network operation chip.

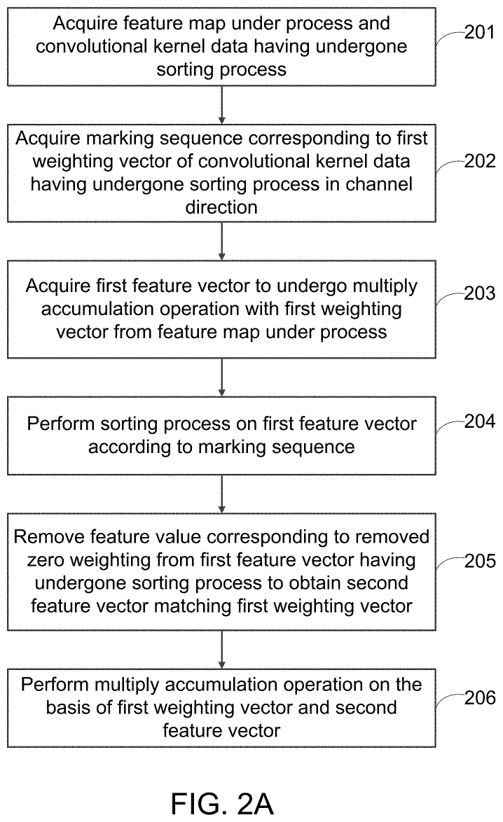

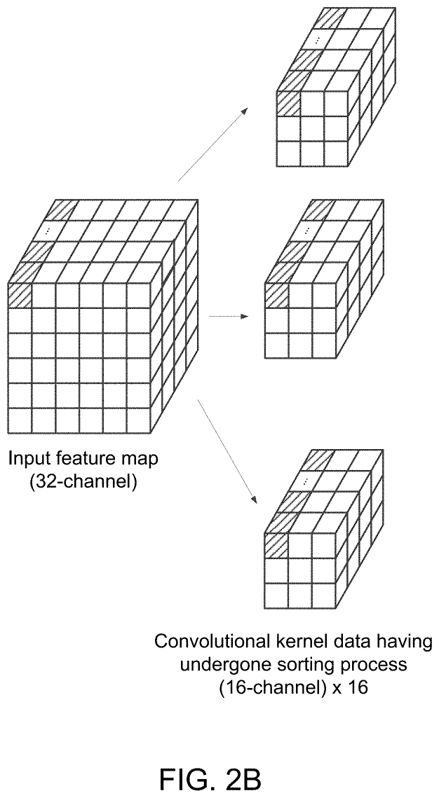

FIG. 2A shows a flowchart of an operation method for a sparse convolutional neural network according to an embodiment of the present invention. Referring to FIG. 2A, the solution is described by taking electronic equipment integrated with an operation apparatus for a sparse convolutional neural network as an execution entity. The electronic equipment includes a processor, a memory, a sorting module and a multiply accumulation operation module (for example, a MAC), wherein the sorting module includes multiple comparators and the multiply accumulation operation module includes multiple multipliers. The memory in the electronic equipment stores convolutional kernel data having undergone a sorting process and corresponding marking sequences.

Specific details of the process of the operation method for a sparse convolutional neural network are described as below.

In step 201, feature map data to be processed (under process) and convolutional kernel data having undergone a sorting process are obtained.

The convolutional kernel data having undergone a sorting process is obtained by performing a sparse data sorting process on first convolutional kernel data.

To perform a convolution operation, data inputted to the operation apparatus includes feature map data and convolutional kernel data. The feature map data may be original image or voice data (e.g., voice data converted to the form of a spectrogram), or feature map data outputted from a previous convolutional layer (or pooling layer). For the current target convolutional layer, all the data above may be considered a feature map under process.

The processor places the convolutional kernel data having undergone the sorting process obtained from the memory to a buffer area. The convolutional kernel data having undergone the sorting process is obtained by performing the sparse data sorting process of the solution described in the embodiments above, and associated specific details are omitted herein for brevity.

In step 202, a marking sequence corresponding to a first weighting vector in the channel direction of the convolutional kernel data having undergone the sorting process is obtained. The first weighting vector is obtained by performing a sorting process and a zero-weighting removal process on a second weighting vector according to the marking sequence.

FIG. 2B shows a schematic diagram of a scenario of an operation method for a sparse convolutional kernel neural network according to an embodiment of the present invention. Referring to FIG. 2B, assume that a target convolutional layer includes 16 sets of convolutional kernel data having undergone a sorting process, the number of channels of first convolutional kernel data is 32, the number of channels of the convolutional kernel data having undergone the sorting process is 16 (the grids in the channel direction in the drawing are merely illustrative and not all 16 channels are depicted), the number of channels of the feature map under process is 32 (the grids in the channel direction in the drawing are merely illustrative and not all 32 channels are depicted), and the calculation ability of one MAC is 256 (that is, 256 multiplication operations can be performed simultaneously at a time). When the MAC performs the operation for the first time, first first weighting vectors (as shown by the shaded parts in FIG. 2B) are respectively fetched from the 16 sets of convolutional kernel data having undergone a sorting process to obtain a total of 16 first weighting vectors, and the first feature vector (as shown by the shaded parts in FIG. 2B) is read from the feature map under process. The processor controls the sorting module to perform the sorting and feature value removal processes according to the solution described below to obtain a second feature vector matching the first weighting vectors. All the first weighting vectors and the second feature vector have a length of 16. This second feature vector and the 16 first weighting vectors are inputted to the MAC for a multiply accumulation operation. Each of the first weighting vectors and the second feature vector are to undergo an inner product operation, and so the multiply accumulation operation is performed for a total of 16×16 times and 16 feature values are outputted.

It is seen from the process above that, in the operation involved each time, the first feature vector undergoes an inner product operation with a different first weighting vector, and the marking sequences corresponding to individual second weighting vectors are different from another, that is, the changes in the positions of the weightings of each of the first weighting vectors are different. Thus, before the inner product operation is to be performed each time on the first feature vector and the different first weighting vectors, the sorting and feature value removal processes need to be performed on the corresponding marking sequence according to the first weighting vectors.

In the embodiment shown in FIG. 2B above, the operation performed once by the MAC is a multiply accumulation operation on one second feature vector and 16 first weighting vectors inputted to the MAC. In other embodiments, other numbers of first weighting vectors and second feature vectors may be used according to requirements, given that the calculation ability of the MAC is maximized. In addition, regardless of the number of vectors used, the calculation principles are the same, and the number of times of multiply accumulation operation needed by the entire convolution operation on the feature map under process is also fixed for the final convolutional kernel data having undergone a sorting process.

Moreover, it is understandable that, for the sorting module, multiple comparators may be work in parallel during the sorting. Taking bitonic sort for example, assuming that the first feature vector has a length of 32, 16 comparators may work in parallel so as to provide higher sorting efficiency. Further, while the MAC performs the multiply accumulation operation, the sorting module may simultaneously perform the sorting process on the next first feature vector needed for the next round of operation to obtain the second feature vector. With such scheduling, the increased sorting steps do not at all increase the overall operation time, but significantly improve the utilization rate of the MAC since sparse data is eliminated, further enhancing the overall operation efficiency.

In step 203, a first feature vector to undergo the multiply accumulation operation with the first weighting vector is obtained from the feature map under process.

In step 204, the sorting process is performed on feature values in the first feature vector according to the marking sequence.

In one round of operation, the first feature vector that is to undergo the multiply accumulation operation with the obtained first weighting vector is obtained from the buffer area, and sorting is performed on the first feature vector according to the marking sequence.

For example, referring to FIG. 10, for the first output feature value R00, the feature value matching the weighting F00 is A0. Thus, since a change has occurred in the position of F00 in the depth direction during the sparse data sorting process, the position of A0 before the convolution operation also needs to be adjusted to the same position, and so the first feature values (A0, A1, A2, . . . , An) need to undergo the sorting process according to the same method used for the second weighting vectors (F00, F01, F02, . . . , F0n). Moreover, (F00, F01, F02, . . . , F0n) are sorted according to the corresponding marking sequence in the sparse data sorting process, and for the same marking sequence, the sorting process stays constant regardless of the number of times of sorting performed. Thus, the first feature values (A0, A1, A2, . . . , An) may be sorted according to the marking sequence.

For example, in one embodiment, the sorting process is performed on the marking sequence according to the bitonic sort algorithm, until first values not less than a first predetermined threshold are arranged on one end of the marking sequence. During the sorting process, each time when a change occurs in the position of a value in the marking sequence, the position of the feature value on the same position in the first feature vector is correspondingly adjusted. Associated specific principles can be referred from the description on the sparse data sorting process of the second weighting vector above, and are omitted herein.

In step 205, the feature value corresponding to the removed zero weighting is removed from the first feature vector having undergone the sorting process, so as to obtain a second feature vector matching the first weighting vector.

In step 206, a multiply accumulation operation is performed on the basis of the first weighting vector and the second feature vector.

Once the sorting is complete, a part of the sorted first feature vector that exceeds the first weighting vector is removed. The number of the feature values of the exceeding part are in one-on-one correspondence with the zero weightings removed from the second weighting vector during the sparse data sorting process. Assuming that 16 zero weightings arranged on one end of the second weighting vector during the sparse data sorting process, 16 feature values arranged on one end of the sorted first feature vector need to be similarly removed, so as to obtain the second feature vector matching the first weighting vector.

After the second feature vector is obtained, the first weighting vector and the second feature vector are inputted to the MAC for a multiply accumulation operation.

It can be understood that, the process above needs to be repeated in order to complete all the convolution operation on the feature map under process with respect to the convolutional kernel data having undergone the sorting process. For example, according to the convolutional sequence of the convolutional kernel data having undergone the sorting process on the feature map under process, the steps of acquiring the marking sequence corresponding to the first weighting vector in the channel direction of the convolutional kernel data having undergone the sorting process, and performing the multiply accumulation operation on the basis of the first weighting vector and the second feature vector are repeated, until the convolution operation on the feature map under process on the basis of the target convolutional layer is complete. Wherein, the target convolutional layer includes one or more sets of convolutional kernel data having undergone a sorting process.

In actual implementation, the present invention is not limited to the execution sequence of the steps described above. Without incurring contradictions, some steps may be performed according to other sequences or be performed simultaneously.

With the solution of the present invention as described above, a sparse data sorting process is performed on convolutional kernel data to eliminate sparse data. In a convolution operation, compression is performed on the feature map under process in the channel direction according to the same principles of the sparse data sorting process, hence significantly reducing the data mount of the convolution operation, improving the operation speed of hardware for a sparse neural network, and preventing waste on hardware performance and computation resources.

In addition, after completing the convolution operation on the feature map on the basis of the target convolutional layer, the method further includes: acquiring an output feature map of the convolution operation; using a next convolutional layer of the target convolutional layer as a new target convolutional layer according to the new feature map under processed obtained according to the output feature map; and returning to the step of acquiring the feature map data under process and the convolutional kernel data having undergone the sorting process on the basis of the new feature map under process and the new target convolutional layer, until the operation of all convolutional layers in the predetermined convolutional neural network is complete.

For a predetermined convolutional neural network including multiple convolutional layers, after the operation of one convolutional layer is complete, the output feature map of the convolutional layer, or a feature map outputted after a pooling layer process of the output feature map, is used as the new feature map under process, and the operation is continued by using the next convolutional layer as the new target convolutional layer, until the operation of all the convolutional layers in the predetermined convolutional neural network is complete.

In order to implement the method above, an operation apparatus for a sparse convolutional neural network is further provided according to an embodiment of the present invention. The operation apparatus for a sparse convolutional neural network may be specifically integrated in terminal equipment such as a cellphone or a tablet computer.

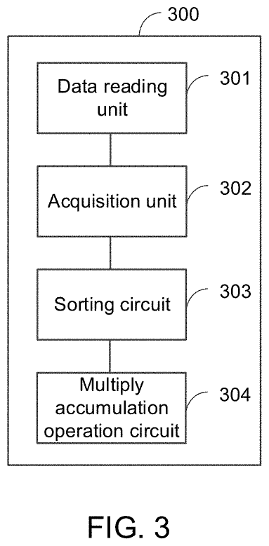

FIG. 3 shows a schematic diagram of a structure of an operation apparatus 300 for a sparse convolutional neural network. Referring to FIG. 3, the operation apparatus for a sparse convolutional neural network may include a data reading unit 301, an acquisition unit 302, a sorting circuit 303 and a multiply accumulation operation circuit 304. The reading unit 301 acquires feature map data under process and convolutional kernel data having undergone a sorting process, wherein the sorting process convolutional kernel data may be obtained by means of sparse data sorting on the first convolutional kernel data by the sparse data sorting method described above. In one embodiment, the feature map data under process and convolutional kernel data having undergone a sorting process are stored in a memory. The data reading unit 301 may include or use a memory controller to read the feature map data under process and convolutional kernel data having undergone a sorting process from the memory, and to store the read data in a buffer.

The acquisition unit 302 acquires a marking sequence corresponding to a first weighting vector of the convolutional kernel data having undergone the sorting process. The first weighting vector is obtained by performing a sorting process and a zero-weighting removal process on a second weighting vector according to a marking sequence, the second weighting vector is a weighting vector of the first convolutional kernel data in the channel direction, and the marking sequence is generated according to positions of zero weightings in the second weighting vector. The acquisition unit 302 also acquires a first feature vector that is to undergo a multiply accumulation operation with the first weighting vector from the feature map under process. In one embodiment, the acquisition unit 302 reads the marking sequence from the memory or the buffer, and obtains the first feature vector from the buffer.

The sorting circuit 303 performs a sorting process on feature values in the first feature vector according to the marking sequence, and removes from the sorting processed first feature vector a feature value matching a zero weighting removed in the zero weighting removal process so as to obtain a second feature vector matching the first weighting vector. In one embodiment, the sorting circuit 303 reads and writes the feature values of the first feature vector from and to a buffer so complete the sorting process. The multiply accumulation operation circuit 304 performs a multiply accumulation operation on the basis of the first weighting vector and the second feature vector. In one embodiment, the multiply accumulation operation circuit 304 is formed by multiple multipliers and an adder. The operation apparatus for a sparse convolutional neural network provided by the embodiment of the present invention and the operation method for a sparse convolutional neural network in the embodiment described above belong to the same concept, any method provided by the embodiments of the operation method for a sparse convolutional neural network may be operated on the operation apparatus for a sparse convolutional neural network, and the specific implementation details can be referred from the embodiments above and are omitted herein.

The operation method and apparatus for a sparse convolutional neural network and a computer-readable storage medium provided by embodiments of the present invention are described in detail above. The principles and implementations of the present invention are described by way of specific examples in the literature. It is to be understood that the description of the embodiments are for better understanding the methods and core concepts of the present invention. Modifications may be made to specifical implementations and applications by a person skilled in the art according to the concept of the present invention, and thus it is to be understood that the disclosure above is not to be construed as a limitation to the present invention.

What is claimed is:

1. An operation method for a convolutional neural network, applied to an electronic apparatus, a memory in the electronic apparatus storing convolutional kernel data having undergone a sorting process, the operation method comprising:
performing the sorting process on a first feature vector of feature map data under process according to a marking sequence corresponding to a first weighting vector of the convolutional kernel data having undergone the sorting process;
removing a part of feature values in the first feature vector having undergone the sorting process to generate a second feature vector; and
performing a multiply accumulation operation on the basis of the first weighting vector and the second feature vector;
wherein, the convolutional kernel data having undergone the sorting process is obtained by means of sorting and zero-weighting removal processes, and the marking sequence is generated according to the sorting and zero-weighting removal processes corresponding to the first weighting vector.

2. The operation method for a convolutional neural network according to claim 1, wherein the marking sequence is generated by replacing, in a second weighting vector of the convolutional kernel data having undergone the sorting process, a zero weighting by a first value and a non-zero weighting by a second value, and performing sorting.

3. The operation method for a convolutional neural network according to claim 1, wherein the first weighting vector is obtained after correspondingly adjusting an order of the second weighting vector while obtaining the marking sequence.

4. The operation method for a convolutional neural network according to claim 2, wherein in the step of removing the part of the feature values in the first feature vector having undergone the sorting process, the removed feature values correspond to the first values in the marking sequence.

5. The operation method for a convolutional neural network according to claim 1, wherein the convolutional kernel data having undergone the sorting process comprises a plurality of first weighting vectors, and the plurality of first weighting vectors have a same length.

6. A data sorting method for a convolutional neural network, comprising:
acquiring first convolutional kernel data;
splitting the first convolutional kernel data into a plurality of second weighting vectors in a channel direction;
generating a plurality of marking sequences corresponding to the second weighting vectors according to positions of zero weightings in the second weighting vectors;
performing a sorting process on weighting values in the second weighting vectors according to the marking sequences so that the zero weightings are arranged on one ends of the second weighting vectors; and
removing at least one zero weighting arranged on the one ends of the second weighting vectors to obtain a plurality of corresponding first weighting vectors;
wherein, the first weighting vectors form the convolutional kernel data having undergone the sorting process. The data sorting method for a convolutional neural network according to claim 6, wherein the first weighting vectors have a same length.

8. The data sorting method for a convolutional neural network according to claim 6, wherein in the step of generating the marking sequences corresponding to the second weighting vectors, the marking sequence is generated by replacing, in the second weighting vectors, the zero weighting by a first value and non-zero weightings by a second value.

9. The data sorting method for a convolutional neural network according to claim 8, wherein the step of generating the marking sequences corresponding to the second weighting vectors comprises performing the sorting process on the first value and the second value in the marking sequences so as to arrange the first value on one ends of the marking sequences.

10. The data sorting method for a convolutional neural network according to claim 8, wherein the step of performing the sorting process on the weightings in the second weighting vectors according to the marking sequences performs the sorting process on the weightings in the second weighting vectors according to the sorting process performed on the first values and the second values in the marking sequences.

11. An operation apparatus for a convolutional neural network, applied to an electronic apparatus, a memory in the electronic apparatus storing convolutional kernel data having undergone a sorting process, the operation apparatus comprising:
a sorting circuit, performing the sorting process on a first feature vector of feature map data under process according to a marking sequence corresponding to a first weighting vector of the convolutional kernel data having undergone the sorting process, and removing a part of feature values in the first feature vector having undergone the sorting process to generate a second feature vector; and
a multiply accumulation operation circuit, performing a multiply accumulation operation on the basis of the first weighting vector and the second feature vector;
wherein, the convolutional kernel data having undergone the sorting process is obtained by means of sorting and zero-weighting removal processes, and the marking sequence is generated according to the sorting and zero-weighting removal processes corresponding to the first weighting vector.
